(19) United States
(12) Patent Application Publication
(10) Pub. No.: US 2014/0086100 A1
(43) Pub. Date: Mar. 27, 2014

(54) Multi-Chassis Cluster Synchronization Using Shortest Path Bridging (SPB) Service Instance Identifier (I-SID) Trees

(71) Applicant: AVAYA, INC., Basking Ridge, NJ (US)

(72) Inventors: Srikanth Keesara, Tewksbury, MA (US); Shahaji Bholse, Bedford, MA (US); Sakthivadivu Saravanaraj, Nashua, NH (US)

(73) Assignee: AVAYA, INC., Basking Ridge, NJ (US)

(21) Appl. No.: 13/627,260

(22) Filed: Sep. 26, 2012

(51) Int. Cl. H04L 12/44

(52) U.S. Cl. 370/255

(57) ABSTRACT

A method, apparatus and computer program product for providing synchronization of a multi-chassis cluster using SPB I-SID trees is presented. A plurality of network devices are defined for making up a single cluster. Each network device of the cluster is configured with a same cluster Identifier (cluster ID) and each network device of the cluster signals an Service Instance Identifier (I-SID). At least one ISID multicast tree is generated, each one of the at least one multicast tree rooted at one node of the cluster. Cluster synchronization messages are exchanged between the network devices of the cluster using the at least one multicast tree.

### BACKGROUND

Data communication networks have become increasingly popular. Data communication networks may include various computers, servers, nodes, routers, switches, hubs, proxies, and other devices coupled to and configured to pass data to one another. These devices are referred to herein as “network elements,” and may provide a variety of network resources on a network. Data is communicated through data communication networks by passing protocol data units (such as packets, cells, frames, or segments) between the network elements over communication links on the network. A particular protocol data unit may be handled by multiple network elements and cross multiple communication links as it travels between its source and its destination over the network. Hosts such as computers, telephones, cellular telephones, Personal Digital Assistants, tablets and other types of consumer electronics connect to and transmit/receive data over the communication network and, hence, are users of the communication services offered by the communication network.

Network elements (e.g. Access Points, Mobility Switches and Edge Switches) are typically implemented to have a control plane that controls operation of the network element and a data plane that handles traffic flowing through the network. The data plane typically will have a collection of line cards having ports that connect to links on the network. Data is received at a particular port, switched within the data plane, and output at one or more other ports onto other links on the network. The packets are transferred across the network in accordance with a particular protocol, such as the Internet Protocol (IP). As used herein, the term “cluster” is used to refer to one or more nodes providing node-level resiliency at the network level.

Computer networks can include various configurations. One such configuration includes a link aggregation technology known as Multi-Link Trunking (MLT). MLT is a port trunking or line/cable sharing technology for using multiple network connections in parallel. MLT has been standardized as specified by Institute of Electrical and Electronics Engineers (IEEE) 802.3ad, which is hereby incorporated by reference. MLT typically includes Link Aggregation Control Protocol (LACP) to provide a method to control the bundling of several physical ports together to form a single logical channel. LACP allows a network device to negotiate an automatic bundling of links by sending LACP packets to a peer (directly connected device that also implements LACP). Alternatively, MLT links can be bundled manually. In both configurations, MLT enables grouping several physical Ethernet links into one logical Ethernet link to provide increased bandwidth, speed, resiliency, and several fail-over paths for fault-tolerance. If a given link fails, then the MLT technology will quickly and automatically redistribute traffic across the remaining links.

MLT is generally limited in that the physical ports in a given link aggregation group all reside on the same network switch. Additional MLT technologies address this limitation by enabling physical ports to be split between two network switches. Such technologies that enable splitting physical ports between network switches include Split Multi-Link Trunking (SMLT), Distributed Split Multi-Link Trunking (DSMLT), and Routed Split Multi-Link Trunking (R-SMLT). By splitting physical ports between network switches, split multi-link trunking technologies protect against nodal failure in addition to line card and link failure.

### SUMMARY

Conventional mechanisms such as those explained above suffer from a variety of deficiencies. One such deficiency is that the transport used to carry the cluster synchronization messages does not currently take advantage of the virtualization capabilities of the network used to connect the switches in the cluster. For example, if the network is a Shortest Path Bridging (SPB) Network, the multicast capabilities of the SPB network provide the ability to build a more flexible and powerful cluster solution than current practice allows. SPB in computer networking is a technology that greatly simplifies the creation and configuration of carrier, enterprise, and cloud networks which virtually eliminates human error, while enabling multipath routing.

SPB technology provides logical Ethernet networks on native Ethernet infrastructures using a link state protocol to advertise both topology and logical network membership. Packets are encapsulated at the edge either in MAC-in-MAC 802.1ah or tagged 802.1Q/802.1ad frames and transported only to other members of the logical network. Unicast and multicast is supported and all routing is on symmetric shortest paths. Many equal cost shortest paths are supported.

Conventional switch clustering techniques use Split Multi-Link Trunking (SMLT), wherein two switches are physically connected by a special trunk called inter-switch trunk (IST). The IST control protocol is a point-to-point protocol between the switches in a two switch cluster. SMLT embodiments can also be configured as clusters of nodes with IST links between clusters. The IST is used for control messaging between the two nodes and synchronization of databases.

Embodiments of the invention significantly overcome such deficiencies and provide mechanisms and techniques that provide for the use of SPB multicast transport for a multi-chassis cluster synchronization protocol.

In a particular embodiment of a method for providing the use of SPB multicast transport for a multi-chassis cluster synchronization protocol the method includes defining a plurality of network devices making up a single cluster. The method further includes configuring each network device of the cluster with a same cluster Identifier (cluster ID) and signaling by each network device of the cluster an Service Instance Identifier (I-SID) value. Additionally the method includes generating at least one ISID multicast tree, each one of the at least one multicast tree rooted at one node of the cluster. The method also includes exchanging cluster synchronization messages between the network devices of the cluster using the at least one multicast tree.

Other embodiments include a computer readable medium having computer readable code thereon for providing the use of SPB multicast transport for a multi-chassis cluster synchronization protocol. The computer readable medium includes instructions for defining a plurality of network devices making up a single cluster. The a computer readable medium further includes instructions for configuring each network device of the cluster with a same cluster ID and signaling by each network device of the cluster an I-SID value. Additionally the computer readable medium includes instructions for generating at least one I-SID multicast tree, each one of the at least one multicast tree rooted at one node of the cluster. The computer readable medium also includes instructions for exchanging cluster synchronization messages between the network devices of the cluster using the at least one multicast tree.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides the use of SPB multicast transport for a multi-chassis cluster synchronization protocol as explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing multi-chassis cluster synchronization using shortest path bridging (SPB) service instance identifier (I-SID) trees as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Avaya, Inc. of Basking Ridge, N.J.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a prior art network environment incorporating switch clusters;

FIG. 2 illustrates a network environment incorporating multi-chassis cluster synchronization using Shortest Path Bridging (SPB) Service Instance Identifier (I-SID) trees in accordance with embodiments of the invention; and

FIG. 3 comprises a flow diagram of a particular method for providing multi-chassis cluster synchronization using Shortest Path Bridging (SPB) Service Instance Identifier (I-SID) trees in accordance with embodiments of the invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

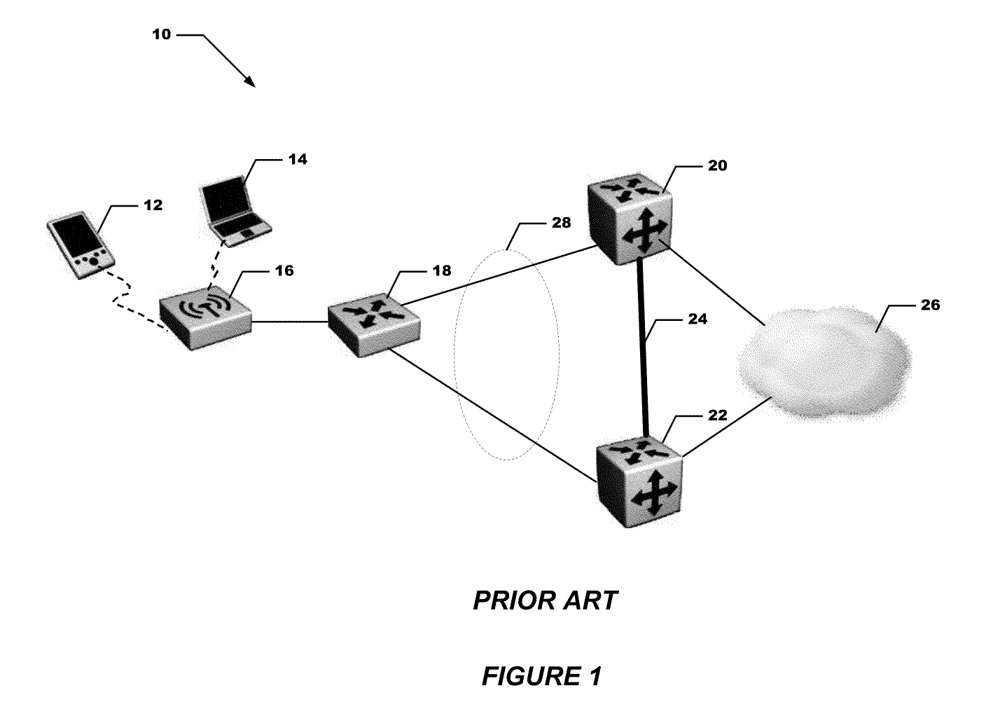

Referring to FIG. 1 a prior art SMLT environment 10 is shown. The network environment 10 includes mobile units 12 and 14 in wireless communication with Access Point (AP) 16. AP 16 is in communication with Access Switch 18 which is in communication with network switch 20 and network switch 22. Network switches 20 and 22 are also referred to herein as mobility switches. Access Switch 18, network switch 20 and network switch 22 are connected to each other via a Split Multi-Link Trunk (SMLT) 24 which provides for extra bandwidth as well as redundancy. The network switches 20 and 22 are configured to run Layer 3 protocols (IPv4 family in particular) as well as an additional proprietary protocol via which they exchange information about their configuration, state, databases and link state. This latter protocol runs over the MLT connection between the two peers that form the RSMLT cluster named Inter-Switch Trunk (IST) 24. Network switch 20 and network switch 22 are peers for each other and part of a cluster. On one side the cluster is connected to the network core 26 and on the other side each peer is connected via SMLT 28 to the Access Switch 18 which is running as a Layer 2 switch and is unaware of the fact that it is connecting to two distinct systems. The Access Switch 18 performs the load-sharing function when forwarding traffic over the SMLT links which is flowing towards the network core. The two RSMLT peers in the cluster install each other's MAC addresses, ARP, IPv4 interface addresses, Access Tunnel assignments, Mobility VLAN associations and Access Point information in their own respective tables, thus making themselves capable of routing traffic destined for their peer, that due to the load-sharing function of the access switch could end up on themselves. By routing the traffic themselves as if the intended recipient, the packets avoid taking an extra hop through the network thus keeping the latency low while providing redundancy.

During normal operation, traffic from the mobile unit 12 and or 14 is captured by the Access Point 16 which encapsulates it in a CAPWAP header and sends it via the Access Tunnel to the RSMLT cluster switch 20 that is the tunnel termination. Due to the load sharing functionality of the Access Switch 18 sitting between the two end-points of the tunnel, traffic is split between the two peers 20 and 22, but regardless of the original intended recipient, the actual recipient decapsulates the packets and routes them through the network core 26. This is achieved by having both peers exchange their respective MAC addresses, IPv4 interface addresses and the VLAN associations, Access Tunnel assignments and their respective AP IPv4 address and the fact that each cluster member marks in its hardware its peer's MAC address as an own address. Tunnel related control traffic between the AP 16 and the tunnel terminal member of the cluster 20, is always forwarded to and processed by the actual cluster member 20 that is the tunnel owner even if the traffic takes an extra hop via its cluster peer 22 due to the load sharing actions of Access Switch 18.

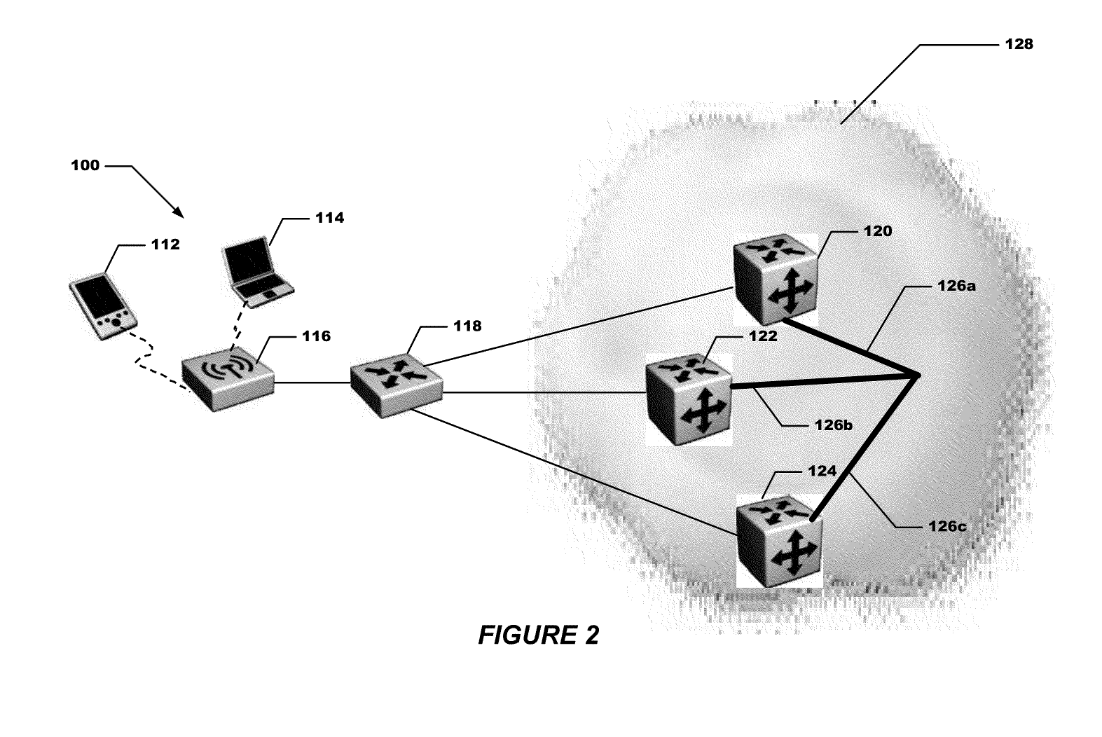

Referring now to FIG. 2 a similar network environment 100 is shown. In accordance with the presently described multi-chassis cluster synchronization using SPB I-SID trees, a group of switches 120, 122 and 124 are identified by the operator of a SPB Network 128 as members of a single cluster and configured with a “Cluster ID” (24-bits or less) representing the cluster. While this example shows a three switch cluster, it should be understood that any number of switches could be clustered together. This provides a significant advantage over conventional MLT environments.

Each of the switches in the cluster 120, 122 and 124 signal IEEE802.1aq ISID-TLV with both TX and RX bits sets, where the ISID value signaled is the same as the Cluster-ID. This results in the generation of I-SID multicast trees 126a, 126b, and 126c, each one rooted at one of the nodes in the cluster which acts as the transmitter on the tree and the other nodes in the cluster are the receivers on the tree. A first tree 126a would be rooted at switch 120 and include switches 122 and 124, a second tree 126b would be rooted at switch 122 and include switches 120 and 124, and a third tree 126c would be rooted at switch 124 and include switches 122 and 120. This provides a full mesh multicast connectivity between all the nodes in the cluster. Alternately, there may be only a single tree (e.g. a combination of 126a, 126b and 126c) generated for the cluster. The nodes in the cluster exchange the cluster synchronization messages using these multicast trees as the virtualized transport.

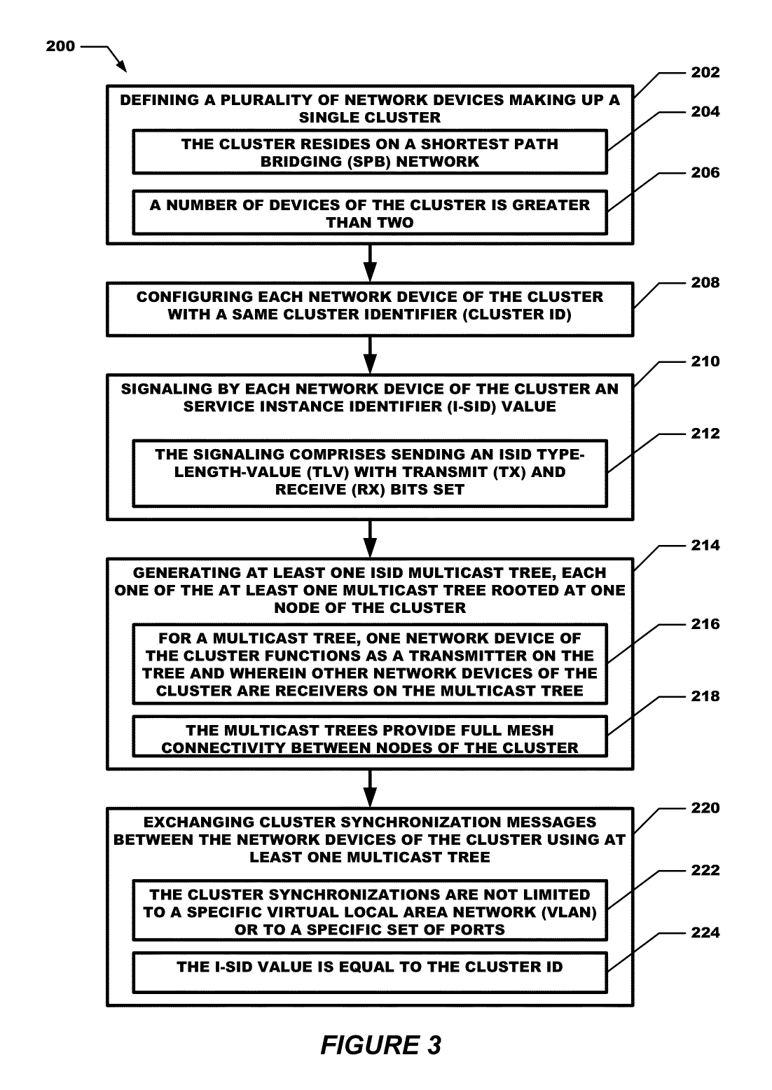

A flow chart of the presently disclosed method is depicted in FIG. 3. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 3, a particular embodiment of a method 200 for providing multi-chassis cluster synchronization using SPB I-SID trees is shown. Method 200 begins with processing block 202 which discloses defining a plurality of network devices making up a single cluster. Any number of devices may be clustered together. As shown in processing block 204, the cluster resides on a Shortest Path Bridging (SPB) network. As further shown in processing block 206 a number of devices of the cluster is greater than two.

Processing block 208 states configuring each network device of the cluster with a same cluster Identifier (cluster ID). This is used to identify members of the cluster.

Processing block 210 recites signaling by each network device of the cluster an Service Instance Identifier (I-SID) value. In a particular embodiment the I-SID value is equal to the cluster ID, though other embodiments could provide the I-SID value by other means. In a particular example, as shown in processing block 212, the signaling comprises sending an ISID type-length-value (TLV) with transmit (TX) and receive (RX) bits set.

Processing continues with processing block 214 which discloses generating at least one ISID multicast tree, each one of the at least one multicast tree rooted at one node of the cluster. As shown in processing block 216 for a multicast tree, one network device of the cluster functions as a transmitter on the tree and wherein other network devices of the cluster are receivers on the multicast tree. As further shown in processing block 218 the multicast trees provide full mesh connectivity between nodes of the cluster. For example, for a three switch cluster a first tree would be rooted at a first switch and include a second switch and a third switch, a second tree would be rooted at the second switch and include the first and third switches, and a third tree would be rooted at the third switch and include the first and second switches. This provides a full mesh multicast connectivity between all the nodes in the cluster. Alternately, there may be only a single tree generated for the cluster. The nodes in the cluster exchange the cluster synchronization messages using these multicast trees as the virtualized transport.

Processing block 220 states exchanging cluster synchronization messages between the network devices of the cluster using the at least one multicast tree. The cluster synchronization messages include information about their configuration, state, databases and link state.

As shown in processing block 222 the cluster synchronizations are not limited to a specific Virtual Local Area Network (VLAN), limited to a specific set of ports. Processing block 224 recites the I-SID value is equal to the cluster ID. Other embodiments may provide the I-SID value by other means.

The above described method and apparatus for providing multi-chassis cluster synchronization using SPB I-SID trees provides several advantages over conventional SMLT/MLT environments. One advantage is that there is no need to limit the cluster synchronizations to run on a specific VLAN or use only a specific set of ports. Another advantage is that SPB builds the connectivity required to run the cluster synchronization protocol. Still another advantage is that the cluster size is not limited to two, as the use of multicast trees allows any number of nodes to join the cluster. Yet another advantage is that troubleshooting the cluster protocol operation is simplified since any node can join the cluster and monitor all the messages being exchanged.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A computer-implemented method comprising:
defining a plurality of network devices making up a single cluster;
configuring each network device of said cluster with a same cluster Identifier (cluster ID);
signaling by each network device of said cluster a Service Instance Identifier (I-SID) value;
generating at least one ISID multicast tree, each one of said at least one multicast tree rooted at one node of said cluster; and
exchanging cluster synchronization messages between said network devices of said cluster using said at least one multicast tree.

2. The method of claim 1 wherein said cluster resides on a Shortest Path Bridging (SPB) network.

3. The method of claim 1 wherein for a multicast tree, one network device of said cluster functions as a transmitter on said tree and wherein other network devices of said cluster are receivers on said multicast tree.

4. The method of claim 1 wherein said signaling comprises sending an ISID type-length-value (TLV) with transmit (TX) and receive (RX) bits set.

5. The method of claim 1 wherein a number of devices of said cluster is greater than two.

6. The method of claim 1 wherein said multicast trees provide full mesh connectivity between nodes of said cluster.

7. The method of claim 1 wherein said cluster synchronizations are not limited to a specific Virtual Local Area Network (VLAN) or a specific set of ports.

8. The method of claim 1 wherein said I-SID value is equal to said cluster ID.

9. A computer system comprising:
a plurality of network switches, each network switch of said plurality of network switches including:
a memory;
a processor;
a communications interface;
an interconnection mechanism coupling the memory, the processor and the communications interface; and
wherein the memory is encoded with an application providing cluster synchronization, that when performed on the processor, provides a process for processing information, the process causing the computer system to perform the operations of:
defining a plurality of network devices making up a single cluster;
configuring each network device of said cluster with a same cluster Identifier (cluster ID);
signaling by each network device of said cluster an Service Instance Identifier (I-SID) value;
generating at least one ISID multicast tree, each one of said at least one multicast tree rooted at one node of said cluster; and
exchanging cluster synchronization messages between said network devices of said cluster using said at least one multicast tree.

10. The computer system of claim 9 wherein said cluster resides on a Shortest Path Bridging (SPB) network.

11. The computer system of claim 9 wherein for a multicast tree, one network device of said cluster functions as a transmitter on said tree and wherein other network devices of said cluster are receivers on said multicast tree.

12. The computer system of claim 9 wherein a number of devices of said cluster is greater than two.

13. The computer system of claim 9 wherein said I-SID value is equal to said cluster ID.

14. A non-transitory computer readable storage medium having computer readable code thereon for providing cluster synchronization, the medium including instructions in which a computer system performs operations comprising:
defining a plurality of network devices making up a single cluster;
configuring each network device of said cluster with a same cluster Identifier (cluster ID);
signaling by each network device of said cluster an Service Instance Identifier (I-SID) value;
generating at least one ISID multicast tree, each one of said at least one multicast tree rooted at one node of said cluster; and
exchanging cluster synchronization messages between said network devices of said cluster using said at least one multicast tree.

15. The computer readable storage medium of claim 14 wherein said cluster resides on a Shortest Path Bridging (SPB) network.

16. The computer readable storage medium of claim 14 wherein for a multicast tree, one network device of said cluster functions as a transmitter on said tree and wherein other network devices of said cluster are receivers on said multicast tree.

17. The computer readable storage medium of claim 14 wherein said signaling comprises sending an ISID type-length-value (TLV) with transmit (TX) and receive (RX) bits set.

18. The computer readable storage medium of claim 14 wherein a number of devices of said cluster is greater than two.

19. The computer readable storage medium of claim 14 wherein said multicast trees provide full mesh connectivity between nodes of said cluster.

20. The computer readable storage medium of claim 14 wherein said I-SID value is equal to a cluster ID.
